(19) United States
(12) Patent Application Publication
(10) Pub. No.: US 2026/0018728 A1
(43) Pub. Date: Jan. 15, 2026

(54) BATTERY DEVICE

(71) Applicant: SK On Co., Ltd., Seoul (KR)

(72) Inventors: Jeong Woon KO, Daejeon (KR); Dong Jin KIM, Daejeon (KR); Young Suk KIM, Daejeon (KR); Jeong Joo LEE, Daejeon (KR); Jin A JANG, Daejeon (KR)

(21) Appl. No.: 19/216,596

(22) Filed: May 22, 2025

(30) Foreign Application Priority Data
Jul. 9, 2024 (KR) 10-2024-0090208

(51) Int. Cl. H01M 50/244; H01M 50/211; H01M 50/242; H01M 50/289; H01M 50/507

(52) U.S. Cl. CPC H01M 50/244; H01M 50/211; H01M 50/242; H01M 50/289; H01M 50/507

(57) ABSTRACT

A battery device according to the disclosed technology may include a cell assembly in which a plurality of battery cells are stacked, a busbar assembly coupled to one side of the cell assembly, and a cell guide extending from the busbar assembly toward the cell assembly and partially facing both side surfaces of the cell assembly.

### CROSS-REFERENCE TO RELATED APPLICATIONS

This patent document claims the priority and benefits of Korean Patent Application No. 10-2024-0090208 filed on Jul. 9, 2024, the disclosure of which is incorporated herein by reference in its entirety.

### TECHNICAL FIELD

The disclosure and implementations disclosed in this patent document generally relate to a battery device.

### BACKGROUND

Secondary batteries, unlike primary batteries, may be charged with and discharged of electricity, and may be applied to devices within various fields such as digital cameras, mobile phones, laptops, and hybrid cars. Secondary batteries include nickel-cadmium batteries, nickel-metal hydride batteries, nickel-hydrogen batteries, and lithium secondary batteries.

Among these secondary batteries, lithium secondary batteries with high energy density and discharge voltage are being widely studied. Recently, lithium secondary batteries are used in the form of battery modules or battery packs that connect a plurality of flexible pouch-type battery cells.

However, when the plurality of battery cells are placed in one case, if one battery cell expands, the other battery cells may be bent, and if this condition continues, this can cause deterioration of the battery cells.

Accordingly, even if a swelling phenomenon occurs, a method is required to prevent other battery cells from deteriorating.

### SUMMARY

According to an aspect of the disclosed technology, a battery device capable of suppressing deterioration of a battery cell due to swelling may be provided.

The battery device of the disclosed technology may be widely applied to electric vehicles, battery charging stations, and devices within green technology fields such as solar power generation and wind power generation using other types of batteries. Additionally, a battery case of the disclosed technology may be used in eco-friendly electric vehicles, hybrid vehicles, or the like, for ameliorating the effects of climate change by suppressing air pollution and greenhouse gas emissions.

A battery device according to the disclosed technology may include: a cell assembly in which a plurality of battery cells are stacked; a busbar assembly coupled to one side of the cell assembly; and a cell guide extending from the busbar assembly toward the cell assembly and partially facing both side surfaces of the cell assembly.

In an embodiment, the battery cell may include an electrode assembly accommodated inside a case, and the cell guide may be disposed in a position in which a portion of the cell guide faces the electrode assembly.

In an embodiment, the busbar assembly may include at least one busbar and an insulating frame to which the at least one busbar is fixedly coupled, and the cell guide may extend from the insulating frame.

In an embodiment, the battery device may further include a fastening member fastening the cell guide to the insulating frame.

In an embodiment, the cell guide may be formed integrally with the insulating frame.

In an embodiment, the battery device may further include a reinforcing frame interconnecting the cell guide and the insulating frame.

In an embodiment, the reinforcing frame may be formed integrally with the cell guide or the insulating frame.

In an embodiment, the battery device may further include: a housing accommodating the cell assembly; and a first buffer pad disposed between the cell assembly and the housing.

In an embodiment, the battery device may further include a second buffer pad disposed between the cell guide and the cell assembly.

In an embodiment, the first buffer pad and the second buffer pad may be formed of the same material.

In an embodiment, a thickness of the first buffer pad may correspond to a total thickness of the second buffer pad and the cell guide.

Additionally, a battery device may include: a cell assembly in which a plurality of battery cells are stacked in a first direction; a busbar assembly coupled to a first side surface of the cell assembly in which an electrode lead of the battery cell is disposed; a housing accommodating the cell assembly and the busbar assembly within an accommodation space; and a cell guide disposed on both second side surfaces of the cell assembly in the first direction and partially reducing the accommodation space of the housing.

In an embodiment, each of the battery cells may include an electrode assembly connected to the electrode lead, and the cell guide may be disposed in a position facing a portion of the electrode assembly to which the electrode lead is connected.

According to an embodiment of the disclosed technology, a surface pressure deviation occurring on a surface of each battery cell when battery cells in a battery device are swollen may be minimized. Accordingly, the battery cell may be prevented from being deteriorated or damaged due to the surface pressure deviation.

### BRIEF DESCRIPTION OF DRAWINGS

Certain aspects, features, and advantages of the disclosed technology are illustrated by the following detailed description with reference to the accompanying drawings.

FIG. 1 is a perspective view of a battery cell based on an embodiment of the disclosed technology.

FIG. 2 is an exploded perspective view of the battery cell illustrated in FIG. 1.

FIG. 3 is an exploded perspective view of a battery device based on an embodiment of the disclosed technology.

FIG. 4 is a plan view of the battery device illustrated in FIG. 3.

FIG. 5 is an exploded perspective view of the insulating frame and cell guide illustrated in FIG. 3.

FIG. 6 is a plan view of the battery device illustrated in FIG. 4, illustrating a state in which swelling has occurred in the battery cell.

FIG. 7 is an exploded perspective view of a battery device based on another embodiment of the disclosed technology.

### DETAILED DESCRIPTION

Hereinafter, the disclosed technology will be described in detail with reference to the attached drawings.

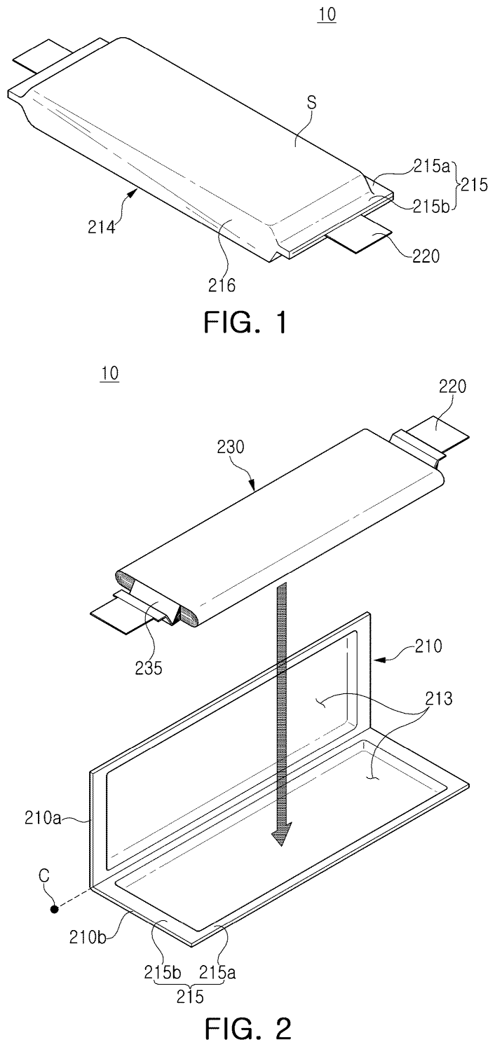

FIG. 1 is a perspective view of a battery cell based on an embodiment of the disclosed technology, and FIG. 2 is an exploded perspective view of the battery cell illustrated in FIG. 1.

Referring to FIGS. 1 and 2, a battery cell 10 according to an embodiment may include an electrode assembly 230 and a case 210 accommodating the electrode assembly 230.

The battery cell 10 according to an embodiment is a rechargeable battery and may include a lithium ion (Li-ion) battery. Since the lithium ion battery has a large capacity per unit volume, the lithium ion battery may be used as an energy source for electric vehicles (EV) or hybrid vehicles (HEV), and may also be used in devise within in various fields such as energy storage.

The electrode assembly 230 is a member in which a plurality of electrodes are stacked, and may be formed in an approximately hexahedral shape and may be accommodated together with an electrolyte in an accommodation space 213 of the case 210.

The case 210 may be formed of a flexible film material. For example, the case 210 may be formed of a material insulating a surface of a metal thin film including aluminum.

The case 210 may be provided with an accommodation space 213 in which the electrode assembly 230 is accommodated inside. Additionally, an electrode lead 220 may be protrudingly disposed on the outside of the case 210.

As illustrated in FIG. 2, the battery cell 10 of an embodiment may seal the accommodation space 213 after folding a single sheet of outer material and bonding three side surfaces. Accordingly, the case 210 of an embodiment may be divided into a first case 210a and a second case 210b based on a folding line C at which the outer material is folded.

Specifically, the battery cell 10 of an embodiment may be manufactured by forming an accommodation space 213 in the outer material through processing, press or the like, accommodating the electrode assembly 230 in the accommodation space 213 and folding the outer material folded along the fold line C, and then, sealing the accommodation space 213 by bonding edges at which the first case 210a and the second case 210b meet each other. A heat-melting method may be used as the method for bonding the edges, but the disclosed technology is not limited thereto.

Hereinafter, a portion in which the electrode assembly 230 is accommodated is referred to as an accommodation portion 214, and an edge portion in which the outer material is bonded is referred to as a sealing portion 215. Depending on the manufacturing method, the battery cell 10 of an embodiment may not have the sealing portion 215 disposed on a side surface 216 (hereinafter referred to as a folding surface) formed by folding the outer material.

In an embodiment, the sealing portion 215 may be divided into a first sealing portion 215a formed in a portion in which the electrode lead 220 is placed, and a second sealing portion 215b formed in a portion in which the electrode lead 220 is not disposed.

Meanwhile, the battery cell 10 of this embodiment may be provided with the accommodation space 213 in each of the first case 210a and the second case 210b. However, the configuration of the disclosed technology is not limited thereto, and various modifications, such as providing the accommodation space 213 in only one of the first case 210a and the second case 210b, may be possible.

Additionally, an electrode tab 235 may be disposed between the electrode assembly 230 and the sealing portion 215. The electrode tab 235 may electrically connect the electrode assembly 230 and the electrode lead 220, and a plurality of electrode tabs 235 may extend from the electrode assembly 230 and may be bonded to at least one electrode lead 220.

The electrode lead 220 may include a cathode lead and an anode lead. At least a portion of the electrode lead 220 may protrude outside the case 210, and the electrode assembly 230 may be electrically connected to external elements through the electrode lead 220.

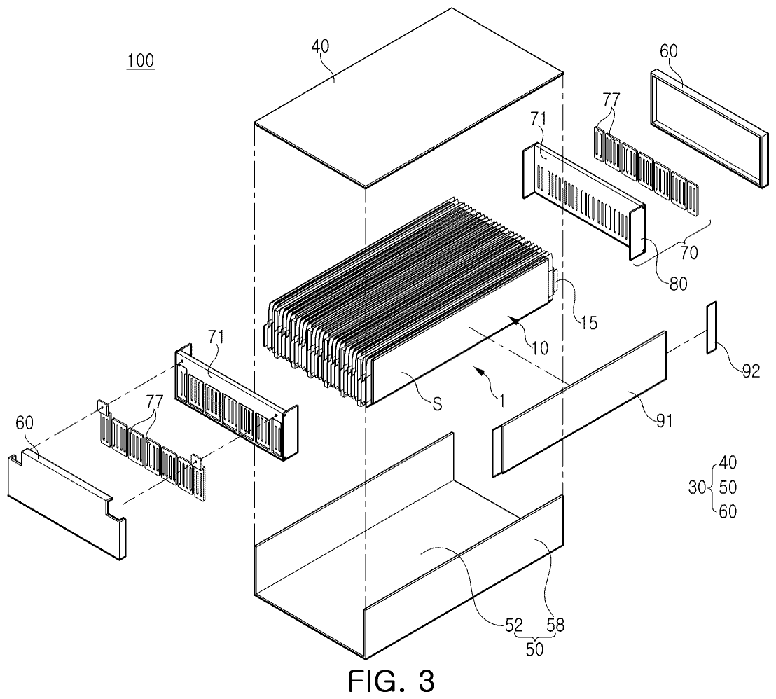

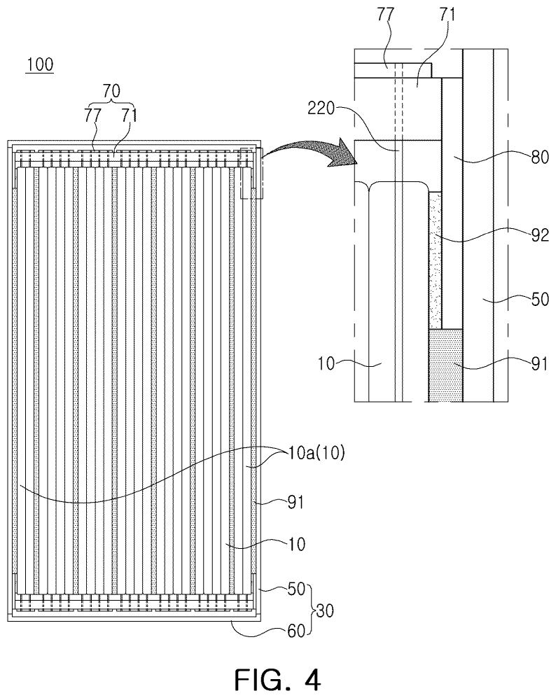

FIG. 3 is an exploded perspective view of a battery device based on an embodiment of the disclosed technology, and FIG. 4 is a plan view of the battery device illustrated in FIG. 3. Here, in FIG. 4, a second housing 40 for convenience of explanation is illustrated as being omitted.

Referring to FIGS. 3 and 4 together, a battery device 100 of an embodiment may include a cell assembly 1 in which a plurality of battery cells 10 are stacked, a busbar assembly 70 coupled to one side of the cell assembly 1, and a cell guide 80 extending from the busbar assembly 70 toward the cell assembly 1 and disposed to partially face both side surfaces of the cell assembly 1.

In this embodiment, the cell assembly 1 may be formed by stacking a plurality of battery cells 10 in a first direction, and the busbar assembly 70 may be coupled to a first side surface of the cell assembly 1 in which the electrode lead 220 of the battery cell 10 is disposed. Additionally, the battery device 100 may include a housing 30 accommodating the cell assembly 1 and the busbar assembly 70 within the accommodation space 213, and the cell guide 80 may be disposed on both second side surfaces of the cell assembly 1 in the first direction and partially reducing the accommodation space 213 of the housing 30.

Each of the battery cells 10 may be a pouched type secondary battery, and the electrode leads 220 may be formed to be oriented in opposite directions. The battery cell 10 configured in this manner is a secondary battery capable of repeated charging and discharging, and may be a lithium (Li) battery or a nickel-metal hydride (Ni-MH) battery.

The cell assembly 1 may be accommodated in the housing 30.

The housing 30 may define an outer shape of the battery device 100, and may surround the cell assembly 1 and may protect the battery cells 10 from external environments.

For easy manufacturing of the battery device 100, the housing 30 may be divided into multiple parts. For example, the housing 30 of an embodiment may include a first housing 50 disposed on one side (e.g., a lower side) of the cell assembly 1, a second housing 40 disposed on the other side (e.g., an upper side) of the cell assembly 1, and a third housing 60 disposed on a side surface on which the electrode leads 220 of the battery cells 10 are disposed.

The first housing 50 may include a lower plate 52 disposed on a lower portion of the cell assembly 1 to support a lower surface of the cell assembly 1, and a side plate 58 supporting the side surface of the cell assembly 1. The side plate 58 may support both side surfaces of the cell assembly 1 in which the electrode leads 220 are not disposed.

The side plate 58 may be formed by extending from both sides of the lower plate 52, and may support the battery cells 10 disposed on both side surfaces of the cell assembly 1 stacked in left and right directions.

The second housing 40 may be disposed on an upper portion of the cell assembly 1 and may be coupled to the first housing 50. The second housing 40 may be provided in the form of a flat plate and may be fastened to an upper end of the side plate 58 of the first housing 50.

The first housing 50 and the second housing 40 may be coupled to each other by welding or the like. However, the disclosed technology is not limited thereto, and various modifications, such as coupling by a sliding manner or coupling using a fixing member such as a bolt or screw, may be made.

The first housing 50 and the second housing 40 configured in this manner may be formed of a material having high thermal conductivity and rigidity, such as a metal.

Meanwhile, in this embodiment, a case in which the side plate 58 is included in the first housing 50 is given as an example, but this embodiment is not limited thereto, and the second housing 40 may include the side plate 58 as needed.

The third housings 60 may be respectively coupled to both side surfaces of the cell assembly 1 in which the electrode leads 220 are disposed. The third housings 60 may be coupled to the first housing 50 and the second housing 40 to form an overall appearance of the battery device 100 together with the first housing 50 and the second housing 40.

The third housings 60 may be coupled to the first housing 50 and the second housing 40 using a fastening member such as a screw or bolt, or by welding, bonding, or the like. However, the configuration of the disclosed technology is not limited to this.

In an embodiment, the third housings 60 may be formed of a metal material. However, this embodiment is not limited to this, and part or all of the third housings 60 may also be formed of an insulating material such as a resin, as needed.

The busbar assembly 70 may be interposed between the third housing 60 and the cell assembly 1.

The busbar assembly 70 may be disposed on a side surface on which the electrode leads 220 of the battery cells 10 are disposed and may be coupled to the cell assembly 1, and may include at least one busbar 77 and at least one insulating frame 71 for this purpose.

The insulating frame 71 may be formed of an insulating material, and at least one busbar 77 may be fixedly coupled to one surface of the insulating frame 71. The electrode leads 220 of the battery cells 10 may penetrate through the insulating frame 71 and may be bonded to the busbar 77, so that the battery cells 10 may be electrically connected to each other through the busbar 77.

Additionally, the battery device 100 of an embodiment may include a cell guide 80 extending from the insulating frame 71.

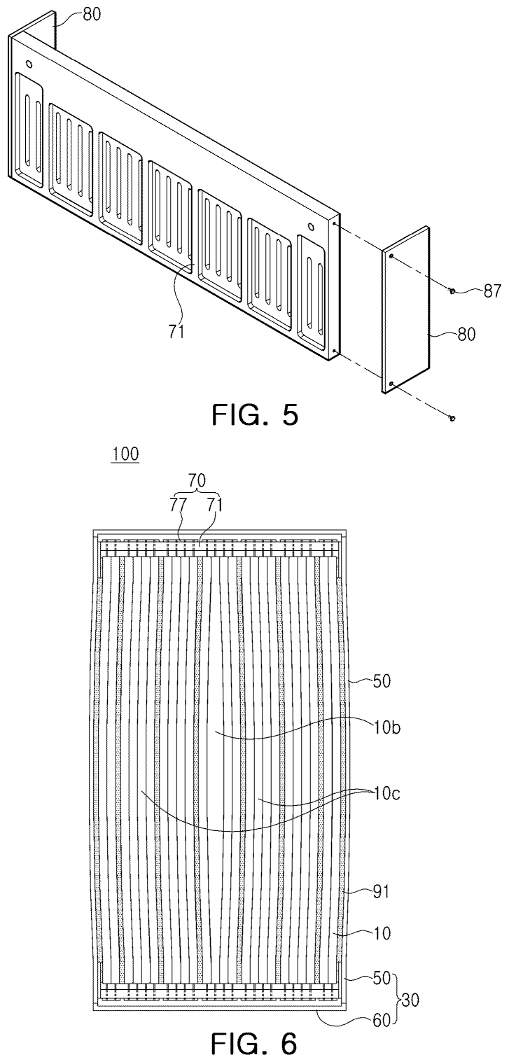

FIG. 5 is an exploded perspective view of the insulation frame and cell guide illustrated in FIG. 3, and referring to the drawings together, the cell guide 80 may be disposed in a form that extends from an edge of the insulation frame 71 toward the battery cell 10, and at least a portion thereof may face the accommodation portion 214 (see FIG. 1) of the battery cell 10. Specifically, the cell guide 80 may be fixedly connected to the insulation frame 71 or may be formed integrally with the insulation frame 71, and may be formed to face the accommodation portion 214 of the battery cells 10a (see FIG. 4, hereinafter referred to as outer cells) that are disposed on an outmost side, among the plurality of battery cells 10 forming the cell assembly 1.

Accordingly, the cell guide 80 may be respectively coupled to both side surfaces of the insulation frame 71, and may also be disposed to face two outer cells 10a forming both side surfaces of the cell assembly 1.

The cell guide 80 of an embodiment may be disposed in a position in which a portion thereof faces the electrode assembly 230 of the outer cell 10a. In this case, the cell guide 80 may be disposed in a position facing a portion of the electrode assembly to which the electrode lead 220 is connected, and may be disposed so as not to face a center of the battery cell 10.

For example, when the accommodation portion n 214 is divided into a plurality of regions, e.g., N equal parts (where N is an integer greater than or equal to 3), in a length direction of the battery cell 10, the cell guide 80 may be disposed so as to face a region to which the electrode lead 220 is connected to the electrode assembly 230, among the plurality of regions. Here, all of the plurality of regions may be divided to partially include the electrode assembly 230.

The cell guide 80 of an embodiment may be formed as a rectangular plate, and may be disposed so as to be in close contact with the accommodation portion 214 of the outer cell 10a. However, the disclosed technology is not limited thereto. For example, when the cell assembly 1 may be partially suppressed from expanding in the first direction, the cell guide 80 may be transformed into various forms.

The battery device 100 of an embodiment may include a fastening member 87 fastening the cell guide 80 to the insulating frame 71. The fastening member 87 of this embodiment may include a screw or a bolt. However, the cell guide 80 of the disclosed technology is not limited thereto, and it may be configured to be mutually coupled to the insulating frame 71 in a sliding manner or a fitting manner. Additionally, the cell guide 80 and the insulating frame 71 may be formed integrally, as in another embodiment described below.

In an embodiment, the cell guide 80 may be formed of an insulating material such as a resin. For example, the cell guide 80 may be formed of the same material as the insulating frame 71. However, the disclosed technology is not limited thereto, and the cell guide 80 may also be formed of a metal material or a metal material having an insulating layer formed on a surface, as needed.

A first buffer pad 91 may be disposed between the cell assembly 1 and the housing 30. For example, the first buffer pad 91 may be disposed in a region of an outer surface of the outer cell 10a that does not face the cell guide 80. The first buffer pad 91 may be disposed to prevent the battery cell 10 from being damaged by the housing 30 as the battery cell 10 comes into direct contact with the housing 30.

Additionally, the first buffer pad 91 may be compressed at a certain thickness when the battery cell 10 expands, and may accommodate an increased volume of the battery cell 10. To this end, the first buffer pad 91 may be formed of a material compressed at a certain thickness by an external force and elastically deformed. For example, the first buffer pad 91 may be formed of a foam-type material such as polyurethane foam (PU foam), but is not limited thereto.

Additionally, the first buffer pad 91 may be inserted and disposed between the battery cells 10. Accordingly, even if one battery cell 10 expands, an increase in the overall volume of the battery device 100 may be minimized.

A second buffer pad 92 may be disposed between the cell guide 80 and the outer cell 10a. The second buffer pad 92 may be disposed to prevent the battery cell 10 from being damaged by the cell guide 80 while directly contacting the cell guide 80.

The second buffer pad 92 may be formed of the same material as the first buffer pad 91, but is not limited thereto, and may be formed of various materials as long as this may be elastically compressed at a certain thickness and protect the battery cell 10.

The first buffer pad 91 may be formed to be thicker than the second buffer pad 92. For example, a thickness of the first buffer pad 91 may be formed to correspond to a total thickness of the second buffer pad 92 and the cell guide 80.

The first buffer pad 91 and the second buffer pad 92 may be manufactured separately or may be manufactured integrally and used.

The battery device 100 configured in this manner may suppress expansion according to a stacking direction of the cell assembly 1 through the cell guide 80. This is described in detail as follows.

FIG. 6 illustrates the battery device illustrated in FIG. 4 in a state in which swelling occurs in the battery cell 10.

Referring to FIG. 6 together, when swelling occurs in the battery device 100, different surface pressures may occur on ta surface S (see FIG. 1 and FIG. 2) of the battery cell 10. Here, the surface S of the battery cell 10 is a surface disposed in the thickness direction of the battery cell 10, and may refer to a surface that contacts or faces other battery cells 10 arranged in parallel. For example, the surface S of the battery cell 10 may be understood as a surface disposed in a direction facing the side plate 58 of the housing 30.

For example, when a battery cell 10b (hereinafter referred to as the first cell) that has undergone swelling, among the battery cells 10 forming the cell assembly 1 is expanded, the surface S of the first cell 10b is expanded mainly in a center rather than in both ends thereof. Additionally, other battery cells 10c (hereinafter referred to as the second cell) stacked and disposed on both sides of the first cell 10b may be pressurized and bent by the pressure applied from the expanded first cell 10b.

When the center of the first cell 10b is expanded, the surface pressure applied to the center of the surface S of a second cells 10c within the housing may increase significantly. On the other hand, since both ends of the surface S of the first cell 10b do not have a large volume change as compared to the center thereof, the surface pressure applied to both ends of the second cells 10c may have a small increase amount. As a result, a relatively lower surface pressure may be applied to both ends of the second cells 10c than to the center thereof.

Accordingly, a deviation occurs in the surface pressure applied to the second cells 10c, and this imbalance in the surface pressure may cause deterioration of the battery cell 10. For example, when the surface pressure applied to both ends of the battery cell 10 is weaker than that applied to the center thereof, the current density increases in both ends of the battery cell 10 in which the surface pressure is weak, which may cause lithium to be precipitated in the both ends. Additionally, the precipitated lithium may form lithium dendrites and destroy the separator.

On the other hand, in the case of having a cell guide 80 as in this embodiment, both ends of the battery cell 10 corresponding to the cell guide 80 are suppressed from being expanded in the stacking direction of the battery cell 10. That is, the cell guide 80 of this embodiment may define a smaller space in which both ends of the cell assembly 1 may be expanded than a space in which the center of the cell assembly 1 may be expanded.

Accordingly, when the center and both ends of the first cell 10b are expanded at the same volume, the surface pressure applied to both ends of the second cell 10c may be greater due to the constraints of the space. Accordingly, in the case of having the cell guide 80 of this embodiment, even if the volume of the center of the first cell 10b increases more than that of both ends thereof, a deviation between the surface pressures applied to the center and both ends of the second cell 10c may be minimized.

The battery device 100 of this embodiment described above may suppress local lifting of both ends of the battery cell 10 during battery swelling using the cell guide 80, and may thus minimize the surface pressure deviation. Thus, the battery device 100 may suppress the battery cells 10 from being deteriorated or damaged due to the surface pressure deviation.

Hereinafter, embodiments of the disclosed technology will be additionally described. Inventive examples and comparative examples included in experimental examples are merely illustrative of the disclosed technology and do not limit the scope of the appended claims, and it is obvious to those skilled in the art that various changes and modifications to embodiments may be possible within the scope and technical idea of the disclosed technology, and it is natural that such changes and modifications fall within the scope of the appended claims.

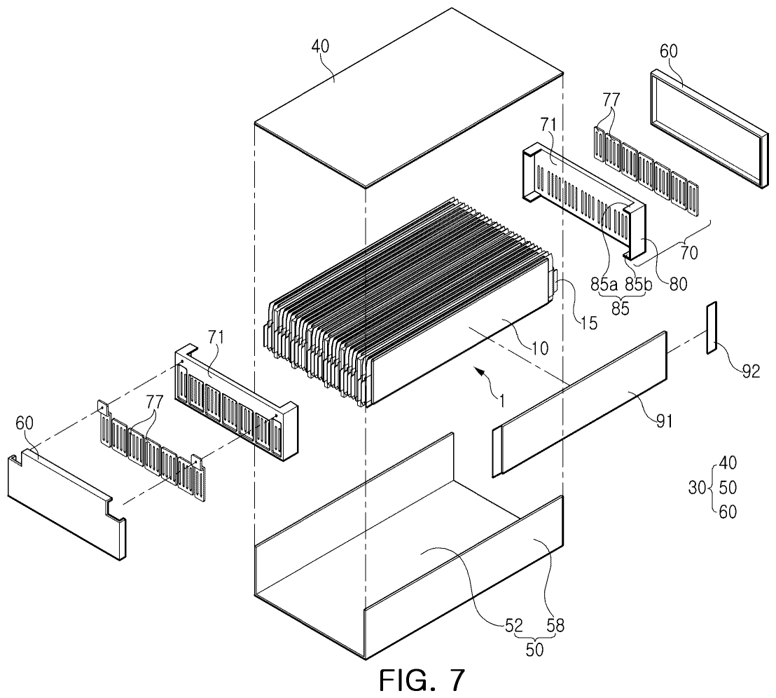

FIG. 7 is an exploded perspective view of a battery device based on another embodiment of the disclosed technology.

Referring to FIG. 7, the cell guide 80 of an embodiment may be formed integrally with the insulating frame 71. The cell guide 80 may be manufactured together with the process of manufacturing the insulating frame 71. In this case, the cell guide 80 may be formed of the same material as the insulating frame 71, and the fastening member 87 described above may be omitted.

Additionally, the battery device 100 of this embodiment may include a reinforcing frame 85 interconnecting the cell guide 80 and the insulating frame 71. A plurality of reinforcing frames 85 of this embodiment may be coupled to cell guides 80, and may include an upper frame 85a connecting an upper end of the cell guide 80 and an upper end of the insulating frame 71, and a lower frame 85b connecting a lower end of the cell guide 80 and a lower end of the insulating frame 71. However, this embodiment is not limited thereto, and the reinforcing frame 85 of this embodiment may be configured to include only one of the upper frame 85a and the lower frame 85b.

The reinforcing frame 85 may be provided to suppress the cell guide 80 from being excessively deformed in the stacking direction of the cell assembly 1 due to the expansion pressure when the cell assembly 1 is expanded. To this end, the reinforcing frame 85 may be connected to an entire upper (or lower) end of the cell guide 80 on one side, and may be disposed so that a portion thereof faces the accommodation portion 214 of the battery cells 10 included in the cell assembly 1.

The reinforcing frame 85 may be formed integrally with the cell guide 80 or the insulating frame 71. For example, the reinforcing frame 85 and the cell guide 80 may be manufactured integrally with the insulating frame 71. However, the disclosed technology is not limited thereto, and various modifications may be possible, such as manufacturing the reinforcing frame 85, the insulating frame 71, and the cell guide 80 separately and then coupling these components together. Additionally, it may also be possible to configure the two upper frames 85a to be connected to each other, and the two lower frames 85b to be connected to each other.

The battery device 100 of this embodiment described above may suppress the cell guide 80 from being deformed when the battery cell 10 swells through the reinforcing frame 85.

What is claimed is:

1. A battery device, comprising:
a cell assembly in which a plurality of battery cells are stacked;
a busbar assembly coupled to one side of the cell assembly; and
a cell guide extending from the busbar assembly toward the cell assembly and partially facing both side surfaces of the cell assembly.

2. The battery device of claim 1, wherein the battery cell includes an electrode assembly accommodated inside a case, and
the cell guide is disposed in a position in which a portion of the cell guide faces the electrode assembly.

3. The battery device of claim 1, wherein the busbar assembly includes at least one busbar and an insulating frame to which the at least one busbar is fixedly coupled, and
the cell guide extends from the insulating frame.

4. The battery device of claim 3, further comprising:
a fastening member fastening the cell guide to the insulating frame.

5. The battery device of claim 3, wherein the cell guide is formed integrally with the insulating frame.

6. The battery device of claim 3, further comprising:
a reinforcing frame interconnecting the cell guide and the insulating frame.

7. The battery device of claim 6, wherein the reinforcing frame is formed integrally with the cell guide or the insulating frame.

8. The battery device of claim 1, further comprising:
a housing accommodating the cell assembly; and
a first buffer pad disposed between the cell assembly and the housing.

9. The battery device of claim 8, further comprising:
a second buffer pad disposed between the cell guide and the cell assembly.

10. The battery device of claim 9, wherein the first buffer pad and the second buffer pad are formed of the same material.

11. The battery device of claim 9, wherein a thickness of the first buffer pad corresponds to a total thickness of the second buffer pad and the cell guide.

12. A battery device, comprising:
a cell assembly in which a plurality of battery cells are stacked in a first direction;
a busbar assembly coupled to a first side surface of the cell assembly in which an electrode lead of the battery cell is disposed;
a housing accommodating the cell assembly and the busbar assembly within an accommodation space; and
a cell guide disposed on both second side surfaces of the cell assembly in the first direction and partially reducing the accommodation space of the housing.

13. The battery device of claim 12, each of the battery cells includes an electrode assembly connected to the electrode lead, and
the cell guide is disposed in a position facing a portion of the electrode assembly to which the electrode lead is connected.
